(19) United States
(12) Patent Application Publication
(10) Pub. No.: US 2011/0261194 A1
(43) Pub. Date: Oct. 27, 2011

(54) SYSTEM FOR PERFORMING CLINICAL TRIALS

(76) Inventor: Sanjay Udani, Northridge, CA (US)

(21) Appl. No.: 13/140,015

(22) PCT Filed: Dec. 17, 2009
(86) PCT No.: PCT/US2009/068601

§ 371 Date: Jul. 15, 2011

Related U.S. Application Data
(60) Provisional application No. 61/138,477, filed on Dec. 17, 2008.

(51) Int. Cl. H04N 7/18; G06F 21/00; H04L 9/32; G06F 17/30; G06F 15/16

(52) U.S. Cl. 348/135; 707/769; 707/812; 726/5; 707/E17.014

(57) ABSTRACT

A system, method and device for monitoring a clinical trial and remotely evaluating the accuracy of data generated during the clinical trial.

### CROSS-REFERENCE TO RELATED APPLICATIONS

The present application claims the benefit of priority from U.S. Patent Application No. 61/138,477, filed on Dec. 17, 2008 and titled METHOD AND DEVICE FOR PERFORMING CLINICAL TRIALS, the disclosure of which is incorporated herein by reference in its entirety.

### BACKGROUND

Before a new drug, medical device, or other therapeutic treatment can be approved for use by and sale to the public, governmental regulatory agencies in most countries require proof that the drug, device or treatment is safe for use and effective in treating a medical condition. To establish this, companies seeking such approval conduct tests of the treatment. These tests may initially involve treating animals and measuring the results, but when the drug is intended for humans, human testing in a clinical trial must be performed.

When a treatment for which regulatory approval is sought involves a drug, for example, the drug must be administered to humans and the results measured. These tests are expensive and time consuming to design and carry out. If errors are made during such human testing, the resulting data may be inaccurate or erroneous, and the test may have to be repeated, delaying the ultimate approval of the drug. Not only does the company seeking approval thereby incur the additional expenses involved in further testing, but it also incurs lost potential income from sales due to the delay.

Data relating to a clinical trial is initially recorded in a source document. Typically, source documents are in paper form. Increasingly, such documents are later entered into an electronic system, which may introduce error into the data. Such data may be entered into such an electronic system in a different order than that with which it was collected, making the tracking of a study's progress with the electronic system difficult. Errors that are typically seen in data from a source document include incomplete entries, illogical entries, illegible entries, incorrect units of measurement recorded, data not being collected to the appropriate decimal point, and data not being collected in the manner prescribed by the respective clinical trial protocol.

The acquisition of clinical trial data is monitored in order to ensure the accuracy and consistency of such data. Such monitoring is expensive and suffers from a lack of consistency due to the use of different monitors, sometimes with different levels of training, at different clinical trial sites. There is also often a time lag between the recording of clinical trial data and the review of such data by a data monitor, such that systematic errors in data acquisition may not be detected or corrected for weeks.

In addition, the process of data monitoring by a data monitor at a clinical trial site may be hindered by a perception from clinicians performing the clinical study that the role of the monitor is to identify errors made by the clinicians. The monitors themselves also may not be subject to consistent scrutiny and management, since they must travel to disparate clinical study sites, generally without a supervisor.

### SUMMARY

In one aspect, the present invention is a method for monitoring data gathered during a clinical trial which comprises the steps of:

(a) creating a case report form (CRF) for recording a plurality of data items relating to the conduct of a clinical trial;

(b) recording the data items in the case report form, wherein each of the recorded data items is associated with a unique identifier;

(c) saving the recorded data items and the associated unique identifiers to a database;

(d) sending one or more of the recorded data items to a reviewer trained to evaluate the one or more recorded data items; and

(e) receiving an evaluation of the recorded data items from the reviewer, wherein each of the recorded data items is determined by the evaluator either to be free from error (in which case it is sent to a separate database for data entry) or to require further evaluation.

The unique identifier can be, for example, a bar code, in which case the CRF is preferably in paper or other non-electronic form. Alternatively, the CRF can be in electronic form, in which case the input device for recording information in the CRF can be any of a number of electronic devices, including a desktop computer, laptop computer, mobile device, handheld device, or phone, for example. One advantage of this method is that the reviewers can be located remotely from the site of the clinical trial and can be uniformly trained to evaluate specific data items, such as blood pressure readings, etc.

In another aspect, the present invention comprises a device for acquiring, managing, and disseminating data relating to clinical trials, comprising:

(a) a biometric scanner for verifying the identity of a user of the device;

(b) a paper scanner for receiving document inputs;

(c) a pill counter for verifying the amount of medication from a subject;

(d) executable instructions for verifying the identity of the user, processing and sorting information from the document inputs, and receiving medication quantity information from the pill counter; and

(e) a processor for executing the instructions.

The device can also preferably include a printer, monitor, and a wireless connection, and preferably also includes a barcode scanner in addition to a document scanner. The device is also preferably portable so that it can be transported to locations where data relating to a clinical trial is acquired.

The present system improves compliance and data quality, significantly reduces time and costs, provides near-real-time monitoring with simultaneous data cleaning, combines site monitoring with data management queries, increases control through metrics and reports, and standardizes clinical service delivery.

### DRAWINGS

FIG. 1 is a diagram illustrating the present method.

FIG. 2 is a schematic diagram of a device for use in accomplishing the present method.

### DESCRIPTION

### Definitions

As used herein, the following terms and variations thereof have the meanings given below, unless a different meaning is clearly intended by the context in which such term is used.

“Case report form” and “CRF” refer to a paper or electronic document for collecting data in a clinical trial. The CRF is preferably the source document, i.e. the document in which information concerning a clinical trial, such as the outcome of a particular test performed within the clinical trial (e.g., a blood pressure measurement) and/or the method of performing the test, is initially recorded. CRF's are also preferably standardized such that the same CRF is used at each site in a particular clinical trial.

“Clinical Research Coordinator” and “CRC” refer to an individual who is responsible for conducting a clinical trial.

“Clinical trial” and “clinical study” mean a research study involving human subjects to assess the safety and/or effectiveness of a medication, device, or other treatment for a medical condition of subjects.

“Clinical trial protocol” is a document that describes the objective(s), design, methodology, statistical considerations, and organization of a clinical trial and details how it is to be performed. A clinical trial protocol allows researchers at multiple locations to perform a clinical trial in the same way, so that their data can be combined.

“Computer” means a machine that manipulates data according to a set of instructions, optionally including a view screen or other display device.

“Query” refers to a data entry or report concerning inaccurate, questionable, or erroneous data identified by a reviewer of a CRF. For examples, a data item in a CRF that identifies a male patient taking female birth control medication could be the subject of a query regarding either the gender of the patient or the identity of the medication. Queries, such as deficiency/discrepancy reports, are directed to appropriate individuals at a clinical trial site for explanation and/or resolution, such as the coordinator of a clinical trial.

“Server” means a computer that receives, stores, and sends data to other computers upon request. A server can implement the instructions of a program stored on the server or elsewhere.

“Subject” and “patient” refer to an individual treated with a medication, medical device, or other form of medical treatment in the course of performing a clinical trial, in particular a human or other mammal.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Virtual Monitoring System and Method

### Information Gathering

The present method of monitoring data in a clinical trial involves the use of a CRF. The CRF records various data items such as the identity of the study, the clinical site, the identity of a patient, patient visit dates, informed consent process information, patient vital signs, adverse event reports, randomization allocation, scheduled visits, medical history, physical examination information, inclusion and exclusion criteria, concomitant medication usage, rescue medication usage, compliance diary, medical procedure results, laboratory test results, scales and questionnaires, progress notes, and other items of information relating to the clinical trial.

In the present method, CRF's are preferably used to record both the outcomes identified by a clinical trial, such as the results of patient testing, as well as the specific methods used to obtain such outcome data, sometimes referred to as metadata. The inclusion of metadata in a CRF used by multiple sites provides for consistency between clinical sites in measuring outcomes and thus more accurate clinical trial results.

In order to allow data items, such as outcome information and metadata, to be later sorted and then evaluated for accuracy by reviewers, relevant data items are each associated with a unique identifier, such as a bar code, which is machine-readable. This allows particular data items to be sorted for review by a reviewer assigned to evaluate such data items, as described further below. The metadata associated with a particular outcome data item is preferably reviewed by the same reviewer, in order to confirm that the outcome data was obtained correctly.

A CRF for use with the present method is preferably emailed to a coordinator at a clinical trial site shortly before a patient visit. The CRF is preferably filled out on the day of the patient's visit and then entered or scanned as an electronic document into a database containing information relating to the clinical trial, preferably on the day of visit with a time/date stamp placed on the electronic document. A scanning log should be filled out by the clinical study site for CRF's in paper form, though it can also be auto-generated by scanning activity. Electronic CRF's should be stored in a secure server. An indication of the receipt and storage of the scanned CRF is preferably sent to the CRC.

Data can be entered into a CRF that is in paper (hard copy) or electronic form. While entering clinical trial data on paper may allow faster data entry in some cases, entering data into the CRF electronically, e.g. by filling out fillable fields in an electronic document, has the advantages of providing an audit trail, a time/date stamp to prevent changes (which is important when the CRF is a source document), a backup that is created on the database server, and/or the ability to evaluate data immediately according to the present method. In this embodiment, the CRF can be entered electronically using a dedicated device having input and viewing capabilities, or alternatively can be input using a portable, general purpose device such as a mobile phone or portable computer, or other device with processing and information storage capabilities.

When paper CRF's are used, they are preferably converted into electronic form, e.g. such as by scanning, in order to be able to upload them to the clinical trial database of the present system. The text of such electronic documents can be converted into a searchable format using optical character recognition, but in view of the errors that such conversion can result in, the use of optical character recognition is not preferred.

### Review of Information by Monitors

Data from scanned CRF's is sorted based on the bar-coding (or other unique identification of data items) included in the CRF. Such bar codes or identifiers can make individual CRF's unique and traceable, and can include, for example, information concerning the identity of the clinical trial, the sponsor of the clinical trial, a particular subject and/or visit, the site, and the identity of the CRC. Such bar codes can be present on only a cover sheet of a CRF, but for CRF's in paper form they are preferably placed on each page. Bar codes or other identifiers can also be associated with particular data items or fields so that the data associated with such fields can be sorted and forwarded to a reviewer as described below.

Individual data items which require monitoring are forwarded, preferably electronically, to reviewers who are trained to evaluate a particular type of data item or items. CRF reviewers are preferably assigned to review CRF's based on priority, in terms of time (e.g., based on the time/date stamp of the CRF) or urgency (e.g., for specialized protocols requiring immediate action). CRF's are also preferably assigned based on the training of the CRF review staff, such as by study, by patient visit, and/or by data item, depending on what item a reviewer has been trained to evaluate. Priorities can be determined by software that manages the CRF data in the database, such that when CRF review technicians access data assigned for them to review it is already prioritized for them.

CRF reviewers are trained to review specific types of data. For example, a reviewer can be specifically trained to review data relating to a subject's vital signs, and such data is preferably forwarded to such a reviewer. The use of such reviewers allows site monitors to focus on enrollment, drug accountability, and investigator/coordinator relations and thus increases the efficiency of site monitors. CRF reviewers identify discrepancies in data items, note such discrepancies, and classify them. Discrepancies can occur, for example, in the identification of the study, site, subject identification number, visit, coordinator, CRF page number, and/or the data field. Such discrepancies are generally collated for a single visit, and a deficiency/discrepancy report is then generated and sent to the clinical trial site and/or to the CRC for the clinical trial. Discrepancies are then generally resolved by the CRC, and a corrected CRF is then uploaded to a system server as described above. Preferably such corrected CRF's are then subjected to the same review process as initially uploaded CRF's in order to confirm that they do not contain errors, i.e. the steps of the present monitoring and review process are repeated.

Importantly, CRF reviewers can be located remotely from a clinical research site, and need not themselves be co-located. A diverse staff of specialist reviewers can thereby be assembled independent of geographic restrictions. Additionally, CRF's can be created in any language and can then be reviewed by CRF reviewers who are fluent in that language. Data items and discrepancy reports or other queries can thus be exchanged between the clinical research site and CRF reviewers electronically, such as via email. Alternatively or in addition, such reports can be stored in a database accessible, for example, by the CRC of the clinical trial, and in one embodiment can be amalgamated in the form of a daily log.

Data items and other information reviewed by CRF reviewers is preferably displayed via a networked, e.g. internet-based interface and can have multiple frames or areas of the interface. Preferably, the interface includes a frame showing the document being reviewed, a frame displaying the parameters to which the document data is expected to conform (e.g., showing relevant sections of laws and/or regulations applicable to such data), and a data entry frame in which queries can be entered. The reviewer interface also preferably does not allow local storage of data reviewed or evaluated by a reviewer, so that the data review process can be monitored and audited.

If errors, inaccuracies, or other discrepancies in a data item are noted by a CRF reviewer, a deficiency report or other query is generated by the reviewer for such data, preferably within 24 hours of receipt of such data. The query can then be sent to a clinical research coordinator or other appropriate individual for resolution. This allows near-contemporaneous discovery and correction of any errors in the data and/or in its collection, which is not possible with current methods of data monitoring for clinical trials occurring at multiple, often geographically dispersed sites.

Once queried data has been either confirmed or corrected, it can be entered into the clinical trial database. Queries and other reports from CRF reviewers can identify potential issues early in a clinical trial so they can be addressed before they become problems. Preferably, resolved CRF documents are saved in their entirety into a clinical trial database, so that the CRF reviewer can view both the discrepancy report relating to such document as well as the resolved CRF document. The discrepancy report can be updated with the date/time of resolution, preferably automatically, based on a time/date stamp applied when the resolved CRF is scanned into the clinical trial database

Monitors in the present method can also be trained and organized in various ways. For example, one or more reviewers can be trained to monitor all patient visits of a single study, which may be occurring at multiple locations. Alternatively, a reviewer can be trained to specifically evaluate a particular type of data, such as patient vital signs, etc. Advantageously, multiple discrepancies relating to a particular CRF can be assembled into a complete query relating to that CRF after it has been reviewed by multiple reviewers.

Data Gathering and Monitoring System

The present system for gathering, recording, and monitoring data associated with a clinical trial includes a server for storing a clinical trial database. The database, when populated with data from a clinical trial, includes a plurality of case report forms, which are preferably source documents, each such form including a plurality of data items relating to the clinical trial. Such data items can be, for example, data relating to the study site, the sponsor, the CRC, a study subject, data representative of health of subject, or data relating to a subject's response to treatment during a clinical trial. Each of these data items is also preferably associated with a unique identifier which is uploaded to the database together with the case report form, so that each of the data items is forwarded to an appropriate reviewer, as described above.

The clinical trial database is preferably secured from unauthorized access, such as through the use of firewalls and access codes. The database also preferably only stores the most recent and up to date version of a CRF.

The present system further comprises a computer which operates according to a set of instructions of a program stored in volatile and/or non-volatile memory. Such instructions can be loaded in hardware, machine-readable media (such as a disk or CD), and/or can be downloaded on the fly (i.e., via an internet browser program). In one embodiment, the computer can be specifically programmed to execute the steps of the present method. Alternatively, the computer can comprise instructions in hardware and/or local memory to obtain information from a server, e.g. over the internet, and can download specific instructions from the server either through a direct connection or over a network.

The program contains a set of instructions that allows the computer to receive one or more of the data items and unique identifiers from the server and display the data items on a visual display so that such data items can be evaluated by a reviewer. The program further allows the computer to receive query data entered by a reviewer or other user of the present system, and to associate such a query with a data item. The program then enables the computer to send the query and data item to a server. A discrepancy report comprising the query and data item is generated either by the program at the computer and then uploaded to the server or by a set of instructions executable by the server. The server stores the discrepancy report. The program operated by the computer preferably does not allow the data items, query, and/or discrepancy report to be saved on a local memory, i.e. memory directly associated with the computer and not associated via a network.

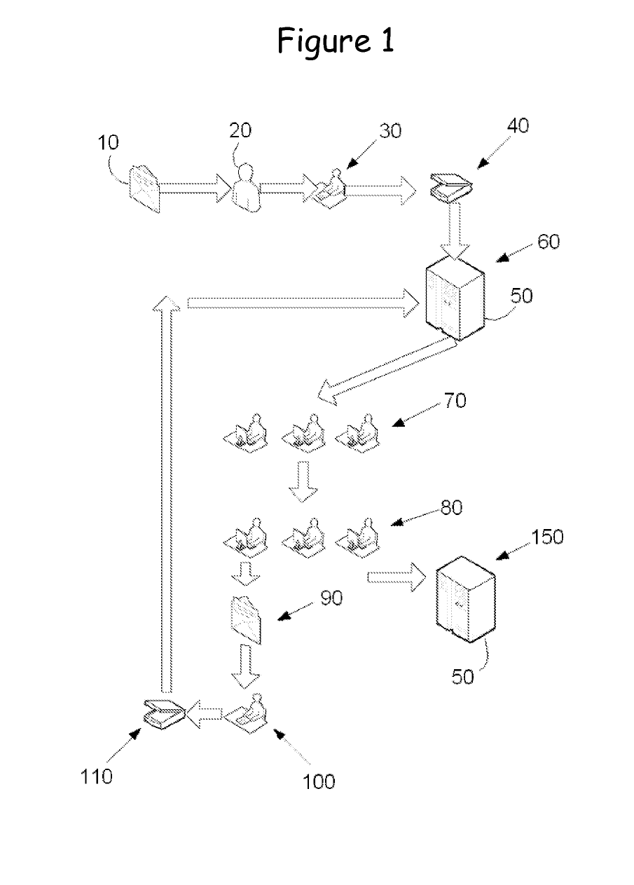

FIG. 1 illustrates an embodiment of the present method and system. In this system, a CRF 10 is sent to a CRC 20, preferably in electronic form such as via email. In a data input step 30, the CRF 10 is filled out by the CRC 20 at the research site. If the CRF 10 is in paper form, it is then scanned in scanning step 40, after which data gathered during the data input step 30 is sent to a server 50 and uploaded into a clinical trial database in an initial uploading step 60. If the data was not entered in electronic form, it is then extracted, such as through data entry and/or optical character recognition, in a data extraction step 70, which can be performed remotely. The data is then sent by the server 50 to a reviewer in reviewing step 80, and the data is reviewed remotely by CRF reviewers trained to review data as described above. If the data is accepted by the reviewers, it is identified as being acceptable and is uploaded to the server 50 in a final uploading step 150. If the data is found to contain errors or other discrepancies, on the other hand, a query concerning such data is entered into the present system and a discrepancy/deficiency report is generated in a report generation step 90. The report is then reviewed and resolved by the CRC in resolution step 100, and a resolved CRF is uploaded to the database. If the resolved CRF is in paper form, it is first scanned in a second scanning step 110.

### ADVANTAGES

The present system and method allow data generated in a clinical trial to be reviewed for errors and then transformed into a corrected or “cleaned” form in near real-time. By providing near real-time data cleaning and validation, the present process allows rolling data locks, i.e. the capture of a set of interim data, thereby enabling an interim analysis, including trend analysis, of study data. Under some circumstances, such trends may lead to a difference in how study subjects are treated, such as the discontinuance of dispensing a placebo to a placebo study group when it becomes unethical to do so in view of the interim data.

By having data reviewed by reviewers trained in reviewing a specific type of data, the quality and validity of the data is also increased. Site-to-site variability in data acquisition and recording is also reduced, since data is reviewed for errors soon after acquisition, and problems or differences in acquisition and recording data at a particular site can be identified and corrected early in the clinical trial. The co-location of monitors having a particular focus or expertise also facilitates quality assessment of such reviewers. The present system and method further eliminate the need for travel by study monitors for most activities, thereby increasing the amount of time and attention available to be spent on important functions as well as reducing cost.

### Data Management Device

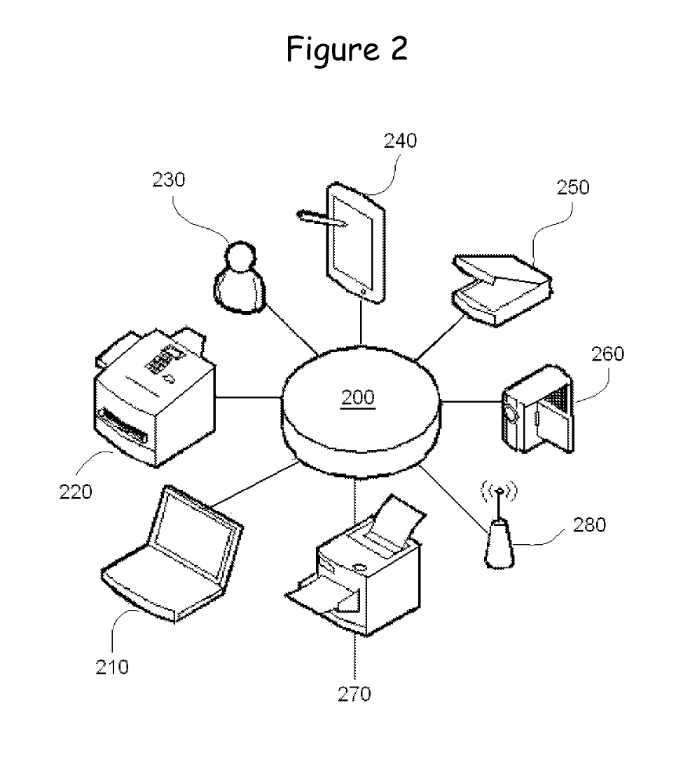

In another embodiment, the present invention comprises a device for obtaining, managing, and disseminating data relating to a clinical trial, in particular a clinical trial accomplished using the present system and method. As shown in FIG. 2, this device 200 preferably comprises a processor 210, which may form part of a computer, a pill counter 220, a biometric scanner 230, an optical scanner 240, a paper scanner 250, a video camera 260, and, optionally, a printer 270 and a transmitter and receiver or transceiver 280 for wireless network access. The transceiver 280 can in some embodiments be substituted by a physical connection to a communications port which places the device 200 in electronic communication with a clinical trial database as described above.

The foregoing components are shown representationally in FIG. 2, but are combined in the present device by being secured within or to a housing. Their operation is under common control by the processor (CPU) of the device, which can also operate to send data collected by the device to a clinical trial database as described above, either through a direct connection or over a network. This combination of components and functionality provides a number of advantages for the performance of clinical trials in connection with the present methods.

The pill counter 220 and the optical scanner 240, for example, provide remote drug accountability and facilitate data gathering with respect to subjects' use of a medication which is the subject of a clinical trial. The optical scanner 240 can be used to verify the identity of the study product container (e.g., the container for pills or other dosage forms of a medication being tested in a clinical trial), and the pill counter can then verify the contents of that container, when a study drug is in pill form. It can also be used to identify paper CRF's and other documents, containers (pill bottles, etc), packages shipped to and from the research site, and inventory sent to and from the research site. The optical scanner 240 is preferably a barcode reader or scanner, such as a laser, LED, or photodiode scanner, although the optical scanner can also make use of other technology, such as camera-based imaging combined with an image processing capability. Such data can be directly uploaded to a clinical trial database using the device 200.

The paper scanner 250 can alternatively or in addition to the optical scanner be used to enter data from paper CRF's, which can then be disseminated to reviewers according to the methods described above using software executed by the processor and using the wireless router or other communications method. The paper scanner 250 is preferably a high speed scanner, i.e. scanning at least 20 pages per minute (one-sided), and more preferably at least 40 pages per minute.

The pill counter 220 is preferably an optical pill counter, i.e. making use of an optical detection system such as a laser, e.g. a laser LED and optical transistor (emitting and receiving a wavelength of light, such as approximately 670 um) or an infra-red LED and optical transistor. Other types of pill counters can also be used, such as those which use weight or other physical measurements to count pills.

By combining the pill counter 220 and optical scanner 240 with a biometric scanner 230, the identity of the individual entering data into the device can be accurately verified, tracked, and reported, thereby facilitating audits and ensuring the integrity of the data gathering process for a clinical trial. For this reason, identification of a user with the biometric scanner 230 is preferably required for all activities involving the present system and method. The biometric scanner 230 can comprise one or more of a number of known devices which can accurately identify an individual based on a unique, intrinsic, generally physical trait, such as a fingerprint or retinal scanning system or a voiceprint recognition system. The use of the video camera 260 in combination with the biometric scanner 230 can provide additional confirmation of the identity of the user of the present device.

The printer 270 can be used to print documents and labels required for the clinical study. For example, when a patient returns a bottle of medication used in a clinical trial, the bottle may contain some remaining medication, and the printer 270 can be used to print adhesive labels (stickers or seals) which contain compliance and accountability data. In a preferred embodiment, two adhesive labels containing the same information are printed, with one being placed on the relevant CRF relating to a bottle of the trial medication and one being placed on the bottle in order to seal the bottle. Advantageously, a remote monitor watches the entire process, such as using the video camera 260, to ensure accountability. The printer 270 can then further print out a shipping label for sending the bottle back to the sponsor or other appropriate organization. In some embodiments, the printer 270 can be eliminated from the present device 200, in which case the device 200 can be configured to operate with a separate printer in communication with the processor 210, such as over a network.

The processor 210 can be either a conventional processor, in which case instructions for operation of the other components of the present device 200 are stored in memory or in other computer readable media, or alternatively the processor 210 can be a special purpose processor with instructions included in read-only memory or other hardware. In one embodiment, the processor 210 is included in a computer, and a display device such as a computer screen is also included. Alternatively or in addition, the processor can be placed in communication with an external computer or other device for inputting clinical trial information, which can be stored in memory in the device 200 and/or directly uploaded from the device 200 to a clinical trial database.

In one embodiment, the present device 200 can also be used by a CRC on site to resolve discrepancies found in a CRF document. The CRC can log in or otherwise identify himself or herself, such as through the use of a biometric scanner, and the device can then provide information concerning such discrepancies to the CRC, such as with an associated printer or electronic viewing screen.

One advantage of using the present device in the performance of a clinical trial is that it allows the recording of information relating to the trial in a way that facilitates the monitoring and auditing of such information for compliance with clinical trial protocols. With respect to information concerning the amount of medication taken by a subject during a clinical trial, for example, the amount of medication given to a patient and the time and date at which it is given can be recorded with the present device by scanning trial and patient information from the bottle (via an identifier such as a bar code) with the device, quantifying the amount of medication with a pill counter, and then automatically saving such information into a clinical trial database together with time and date information. When the subject returns later for a visit, the bottle information can again be scanned in and the remaining amount of medication determined with the pill counter. Not only can this information also be saved into the database, but software associated with the device can determine the patient's compliance with a predetermined clinical trial protocol, i.e. whether the patient has taken the right amount of medication over the period of time between visits, too much medication, or too little. Such software can automatically calculate compliance based on the scanning dates and number of pills returned.

The video camera 260, as mentioned above, can provide still or moving pictures and be used to verify the identity of patients, CRC's, medications, and other aspects of a clinical trial. The video camera 260 can be any of a number of devices able to transmit and/or store video images. The video camera 260 also allows the present device 200 to be used to remotely monitor a clinical trial. The video camera 260 can be used for example by the clinical research staff to communicate with a clinical research sponsor or sponsor's designee about any aspect of a research study, in which case audio receiver and transmission capabilities are also included in the present device 200, such as through the use of a microphone and speaker. In this embodiment, a monitor of the clinical trial can be allowed to monitor a patient visit, for example a visit in which the patient's medication is evaluated using the present device 200. The amount of medication remaining in the bottle returned by the patient can be automatically forwarded to the remote monitor, as can information concerning the amount of medication originally given to a patient, the date that such medication was given, and any deviation from the clinical trial protocol. The ability to receive this information in real time remotely allows the clinical trial monitor to perform monitoring activities remotely and to record the activity monitored as well.

Although the present invention has been discussed in considerable detail with reference to certain preferred embodiments, other embodiments are possible. The steps disclosed for the present methods are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

1. A system for recording and monitoring data associated with a clinical trial, comprising:
(a) a server for storing a clinical trial database, the database comprising a plurality of source documents consisting of case report forms, each case report form comprising a plurality of data items relating to the clinical trial, wherein each of the data items is associated with a unique identifier; and
(b) a computer comprising a set of instructions for a program that allows the computer to:
(i) receive one or more of the data items and unique identifiers from the server and display the data items on a visual display;
(ii) receive query data entered into the computer;
(iii) associate the query data with one of the data items in order to enable the production of a discrepancy report; and
(iv) send the discrepancy report to the server,
wherein the server stores the discrepancy report, and wherein the program operated by the computer does not allow the data items, query, or discrepancy report to be saved on a local memory.

2. The system of claim 1, further comprising a device having a biometric scanner for verifying the identity of a subject participating in the clinical trial, wherein the device is in communication with the server and can upload identity information to the server.

3. The system of claim 1, further comprising a device having a pill counter for verifying the amount of medication given to or received from a subject participating in the clinical trial, wherein the device is in communication with the server and can upload pill count information to the server.

4. The system of claim 1, further comprising a device having an optical scanner for obtaining clinical trial data, wherein the device is in communication with the server and can upload the clinical trial data to the server.

5. The system of claim 1, further comprising a video camera for verifying clinical trial information, wherein the device is in communication with the server and can upload the clinical trial information to the server.

6. The system of claim 1, wherein the instructions are obtained from a networked server and stored in volatile memory of the computer.

7. The system of claim 1, wherein the unique identifier comprises a bar code.

8. The system of claim 1, wherein the program generates the discrepancy report.

9. The system of claim 1, wherein the server generates the discrepancy report.

10. The system of claim 1, wherein the data item is selected from the group consisting of a study site, a sponsor of the clinical trial, a CRC of the clinical trial, a study subject, and health data associated with the subject.

11. A device for use with the system of claim 1 for obtaining and managing data relating to a clinical trial comprising the following components secured to the device:
(a) a biometric scanner for verifying the identity of a user of the device;
(b) a pill counter for verifying the amount of medication given to or received from a subject;
(c) an optical scanner for receiving data;
(d) a video camera;
(e) a processor in communication with the foregoing components of the device for operating the device.

12. The device of claim 11, further comprising a paper scanner for receiving document inputs and/or a printer.

13. (canceled)

14. The device of claim 11, wherein the optical scanner is selected from the group consisting of a laser scanner, an LED scanner, a photodiode scanner, and a camera.

15. The device of claim 11, wherein the pill counter comprises an optical system that includes a laser or an infra-red LED.

16. The device of claim 11, wherein the biometric scanner comprises a system selected from the group consisting of a fingerprint scanning system, a retinal scanning system, and a voiceprint recognition system.

17. The device of claim 11, further comprising an audio receiver and transmitter.

18. A method for monitoring data using the system of claim 1, comprising the steps of:
(a) creating a case report form (CRF) for recording a plurality of data items relating to the conduct of a clinical trial;
(b) recording the data items in the case report form, wherein each of the recorded data items is associated with a unique identifier;
(c) saving the recorded data items and the associated unique identifiers to a database;
(d) sending one or more of the recorded data items to a reviewer trained to evaluate the one or more recorded data items;
(e) receiving an evaluation of the recorded data items from the reviewer, wherein each of the recorded data items is determined by the evaluator either to be free from error or to require further evaluation.
(f) sending completed data to a separate database for data entry

19. The method of claim 18, wherein the reviewer is located remotely from a clinical research site.

20. The method of claim 18, wherein the recorded data items are determined to require further evaluation, further comprising the step of generating a query and sending the query to a clinical research coordinator.

21. The method of claim 18, wherein the CRF is in paper form or in electronic form.

22. (canceled)

23. The method of claim 18, wherein the unique identifier is a bar code.
